(19) United States
(12) Patent Application Publication
(10) Pub. No.: US 2023/0189205 A1
(43) Pub. Date: Jun. 15, 2023

(54) NOTIFICATION DISPLAY STATUS OF A USER EQUIPMENT

(71) Applicant: Telefonaktiebolaget LM Ericsson (publ), Stockholm (SE)

(72) Inventors: Saket RUSTAGI, Delhi (IN); Nipun SHARMA, NEW DELHI (IN); Hans ERIKSSON, SOLLENTUNA (SE); Tushar SABHARWAL, NEW DELHI (IN); Dinand ROELAND, SOLLENTUNA (SE); Deepu GEORGE, BANGALORE (IN)

(21) Appl. No.: 17/921,236

(22) PCT Filed: May 4, 2020
(86) PCT No.: PCT/EP2020/062337

§ 371 Date: Oct. 25, 2022

(51) Int. Cl. H04W 68/00; H04W 28/02

(52) U.S. Cl. CPC H04W 68/005; H04W 28/0215

(57) ABSTRACT

Methods and apparatus are provided. In an example aspect, a method in a User Equipment (UE) in a network is provided. The method includes determining an update of a notification display status of the UE, and providing an indication of the updated notification display status to a node in the network.

### TECHNICAL FIELD

Examples of the present disclosure relate to a notification display status of a User Equipment (UE), and for example providing an indication of the notification display status to a network.

### BACKGROUND

The 3GPP Technical Report (TR) document 23.791 introduces the concept of UE driven analytics” in a 5th generation (5G) wireless communications network, summarized as follows. As UEs in 5G networks can in some examples simultaneously connect to or switch across different network slices, UEs can have a more prominent role for data preparation for network functions (NFs) in the network, such as for example a Network Data Analytics Function (NWDAF) NF. Examples of use cases for this information from the UEs include providing relevant localized contextual information and identifying any changes in the network compared to the past intra-slice and/or cross-slice information they have gathered. The processed information can be used for network slice selection for the UEs. Examples of data that the UE can provide are positioning information (e.g. collected from inertial sensors of the UE, geo-referenced radio data from Wi-Fi or a satellite-based locating system such as GPS), and user profiling information (e.g. when a UE changes environment from outdoor to indoor, or from vehicular to pedestrian mode). Such information may help the NWDAF to make more intelligent decisions on slice selection (e.g. to switch a UE from a slice with more flexible resources to a resilient one or vice versa).

Different types of enhancements can be envisioned for NFs to collect and process UE-driven analytics in order to improve slice selection. In an example, UE Analytics may be provided to the relevant NFs via the User Plane. That is, a UE may optionally add a header to each uplink Protocol Data Uni, (PDU), or additional information to the header, that is populated by the UE with analytics information. The User Plane Function (UPF) removes the optional header before forwarding the uplink PDU to a Data Network. The UPF provides the analytic information from the header to the relevant NFs. The End-to-End Applications whose PDU sessions are used to carry the analytics information may be unaware of the data collection.

### SUMMARY

One aspect of the present disclosure provides a method in a User Equipment, UE, in a network. The method comprises determining an update of a notification display status of the UE, and providing an indication of the updated notification display status to a node in the network.

A further aspect of the present disclosure provides a method in a node in a network. The method comprises receiving an indication of a communication for a User Equipment, UE, in the network, determining a notification display status of the UE, if the notification display status is a first status, causing the communication to be forwarded to the UE, and if the notification display status is a second status, preventing the communication from being forwarded to the U E.

A still further aspect of the present disclosure provides a method in a node in a network. The method comprises receiving an indication of a notification display status of a User Equipment, UE, in the network, and forwarding an indication of the notification display status to a data storage node in the network.

Another aspect of the present disclosure provides apparatus in a User Equipment, UE, in a network. The apparatus comprises a processor and a memory. The memory contains instructions executable by the processor such that the apparatus is operable to determine an update of a notification display status of the UE, and provide an indication of the updated notification display status to a node in the network.

A further aspect of the present disclosure provides apparatus in a node in a network. The apparatus comprises a processor and a memory. The memory contains instructions executable by the processor such that the apparatus is operable to receive an indication of a communication for a User Equipment, UE, in the network, determine a notification display status of the UE, if the notification display status is a first status, cause the communication to be forwarded to the UE, and if the notification display status is a second status, prevent the communication from being forwarded to the UE.

An additional aspect of the present disclosure provides apparatus in a in a node in a network. The apparatus comprises a processor and a memory. The memory contains instructions executable by the processor such that the apparatus is operable to receive an indication of a notification display status of a User Equipment, UE, in the network, and forward an indication of the notification display status to a data storage node in the network.

Another aspect of the present disclosure provides apparatus in a User Equipment, UE, in a network. The apparatus is configured to determine an update of a notification display status of the UE, and provide an indication of the updated notification display status to a node in the network.

A further aspect of the present disclosure provides apparatus in a node in a network. The apparatus is configured to receive an indication of a communication for a User Equipment, UE, in the network, determine a notification display status of the UE, if the notification display status is a first status, cause the communication to be forwarded to the UE, and if the notification display status is a second status, prevent the communication from being forwarded to the U E.

An additional aspect of the present disclosure provides apparatus in a node in a network. The apparatus is configured to receive an indication of a notification display status of a User Equipment, UE, in the network, and forward an indication of the notification display status to a data storage node in the network.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a flow chart of an example of a method in a User Equipment (UE) in a network;

FIG. 2 is a flow chart of an example of a method in a node in a network;

FIG. 3 is a flow chart of an example of a method 300 in a node in a network;

FIG. 4 shows an example of a procedure for sharing terminal analytics in a network;

FIG. 5 shows another example of a procedure for sharing terminal analytics in a network;

FIG. 6 is a schematic of an example of apparatus in a User Equipment (UE);

FIG. 7 is a schematic of an example of apparatus in a node in a network; and

FIG. 8 is a schematic of another example of apparatus in a node in a network.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

In some examples of this disclosure, UE analytics can be used provide an update to the network on certain events at the UE, such as for example using, enabling or starting of certain applications, or enabling or using some functionality within those applications (also referred to herein as apps). Examples of such applications include video streaming applications and gaming applications. Such applications often have certain configurations which prevent one or more notifications (e.g. pop ups, banners, alerts, sounds and/or other types of notifications) from being presented to the user of a UE.

Currently, application specific configurations are localized at the UE, and decisions as to whether to display notifications are made at the UE. This may have certain drawbacks. For example, an incoming call that is not notified to the user may be automatically rejected or diverted to voicemail, for example. However, resources at UE such as battery life may be consumed at the UE by receiving incoming call communications from the network and performing a reject/redirect operation. In addition, in the case of an incoming voice call, network resources for establishing the call with the user may be consumed, and may have been unnecessary due to the UE automatically rejecting or redirecting the call. Below is an example of steps undertaken in the network, when UE A attempts a voice call to UE B, and UE B is not displaying notifications (e.g. because UE B is currently using a video streaming app).

1. UE B initiates a video streaming app, that is associated with a configuration to not display notifications to the user of UE B. For example, the configuration may state “Do not Disturb”.
2. UE A initiates a call towards UE B
3. Call set up in the network domain, including communications between the relevant nodes in the network, including the two UEs, the base stations (gNBs in the case of a 5G network) for each of the UEs and the core network (5GC in the case of a 5G network).
4. Paging and Alerting towards UE B by the base station for UE B.
5. UE B receives call alert and ringing tone from network.
6. UE B does not allow notification or acceptance of the call due to the “Do not disturb” configuration.
7. The user does not see any incoming call indication. Ringing of the call times out due to no answer from UE B.
8. Call is rejected with reason “No Answer”.
9. Call set up response, e.g. from UE B's base station to the core network.
10. Based on parameters associated with UE B, the core network may either reject the call (reason: no answer) or forward the call to another number or to voicemail.
11. Call set up response from the core network to UE A, for example via UE A's base station.

In some examples of this disclosure, a wireless device such as a UE may be associated with a status referred to herein as a “notification display status” that indicates for example whether the UE will display one or more notifications to the user of the UE. The notification display status may be updated, for example as a result of certain actions such as enabling, starting or using certain apps or functionality within those apps. The updated notification display status may for example be notified to the network. The network may then be able to undertake certain actions to improve network efficiency. For example, at least some events may not be notified to the UE depending on the notification display status. In an example, an incoming call for the UE may not be notified to the UE and may instead be automatically rejected or diverted by the network. In another example, an incoming text message or other data event may not be forwarded to the UE. In some examples, when the notification display status of the UE is updated again and notified to the network, notifications of the text messages and/or other data events, and/or any missed calls, may be forwarded or notified to the UE.

Examples of this disclosure are presented in the context of particular network technologies, particularly 5G. However, any example presented herein may be applied to any other appropriate communications technology, including 4G/LTE.

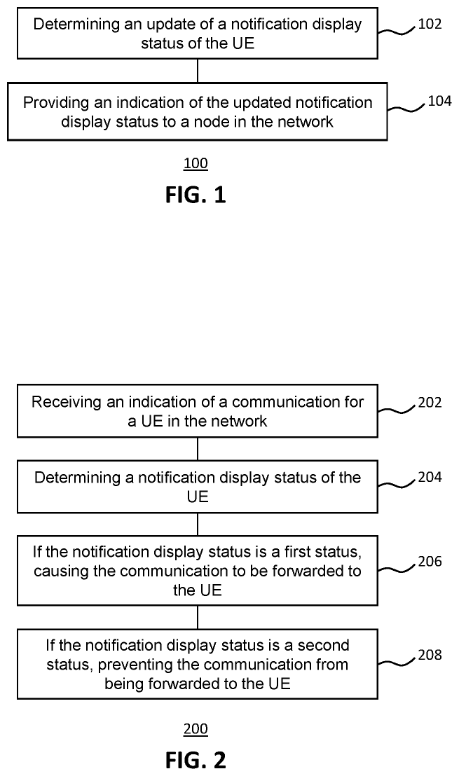

FIG. 1 is a flow chart of an example of a method 100 in a User Equipment, UE, in a network. The method 100 comprises, in step 102, determining an update of a notification display status of the UE. The notification display status may be updated for example as a result of some action by the UE or by a user of the UE. For example, an application such as a video streaming application may be started or some functionality may be enabled or used within the application, whereby the application (or the user) does not wish to present notifications of incoming calls, alerts, texts, emails, application notifications etc. to the user, for example to enhance the user experience. Alternatively, for example, the user may change a setting on the UE to indicate that the user does not wish to view notifications. Alternatively, for example, the update to the notification display status may be made if the user again wishes to receive notifications. In some examples, notifications may be an indication to the user that there is an event of interest, e.g. an incoming call, text message, email or application notification. The notifications may be displayed to the user by the UE in some manner to attract the user's attention, for example by displaying a pop-up window or banner, and/or by playing a sound, and/or by vibrating the UE.

Step 104 of the method 100 comprises providing an indication of the updated notification display status to a node in the network, such as for example a node in the core network associated with the network. The node in the network may comprise for example a User Plane Function, UPF, Session Management Function, SMF, Unified Data Management, UDM, Network Exposure Function, NEF, Network Data Analytics Function, NWDAF, and/or Access and Mobility Management Function, AMF.

In some examples, the indication of the updated notification display status may be provided to the node in the network in a header of one or more Protocol Data Units, PDUs. The PDUs may be for example any PDUs sent by the UE, and in some examples may be unrelated to any application or other cause of the update of the display status. For example, where the notification display status is updated based on some use of a video streaming application, the indication may be provided in a header of a PDU of a PDU session associated with the video streaming application, or a PDU session unrelated to the video streaming application.

In some examples, the notification display status comprises a first status or a second status, wherein the first status indicates that the UE will display one or more notifications and the second status indicates that the UE will not display the one or more notifications. The second status may thus be for example a “Do Not Disturb” status. Where the updated notification status comprises the second status, the method 100 may comprise for example receiving a notification from the network of one or more communications for the UE that were not forwarded to the UE based on the second status. This particular notification may or may not be displayed to the user. The one or more communications may comprise for example an indication of one or missed calls to the user or to the user's UE. In some examples, any missed calls may be automatically rejected or diverted by the network without any attempt to set up the call with the UE, although the above mentioned notification of missed calls may in some examples be sent.

In some examples, the update of the notification display status of the UE may be determined by receiving an indication of the update of the notification status from an application on the UE. For example, an operating system of the UE may receive the indication from the application. Providing the indication of the updated notification display status to the node in the network in step 104 of the method 100 may in some examples comprise providing an indication identifying the application to the node in the network. This may for example enable the network to notify an application server (AS) or other entity of the updated status. For example, the user or the UE may be configured to receive over-the-top (OTT) messages, and the provider associated with the OTT service may be notified by the network of the updated status in some examples, for example where the indication identifies an application associated with the OTT service.

FIG. 2 is a flow chart of an example of a method 200 in a node in a network. The node in the network may be for example a node in a core network such as a User Plane Function, UPF, Session Management Function, SMF, Network Data Analytics Function, NWDAF, or Access and Mobility Management Function, AMF. The method 200 comprises, in step 202, receiving an indication of a communication for a User Equipment, UE, in the network. The communication may be for example one or more text messages, alerts, emails, incoming calls, and/or application notifications, or other type of communication. The indication may be received for example from a source of the communication (e.g. another UE or email server) or from a service provider associated with the communication.

Step 204 of the method comprises determining a notification display status of the UE. This may in some examples comprise retrieving the notification display status from a data storage node in the network such as a Unified Data Management, UDM. The UDM may have previously been provided in some examples with the UE's notification display status, for example in response to the method 100 above. In some examples, the first status indicates that the UE will display one or more notifications, and the second status indicates that the UE will not display the one or more notifications (e.g. “Do Not Disturb”).

Step 206 of the method 200 comprises, if the notification display status is a first status, causing the communication to be forwarded to the UE (e.g. forwarding the communication to the UE), and step 208 comprises, if the notification display status is a second status, preventing the communication from being forwarded to the UE (e.g. refraining from forwarding the communication to the UE). In particular examples, if the notification display status indicates that the UE will not display notifications, network resources may be saved by not forwarding the communication to the UE (e.g. an incoming call), when the user will not be aware of the communication due to lack of notifications. The incoming call may instead for example be forwarded to voicemail or an alternative number, e.g. by the node or some other node in the network. Where the call is forwarded to an alternative number, the indication of the notification display status may also include an indication of the alternative number.

In some examples, the method 200 comprises, if the notification display status is a second status, providing a notification of the communication to the UE.

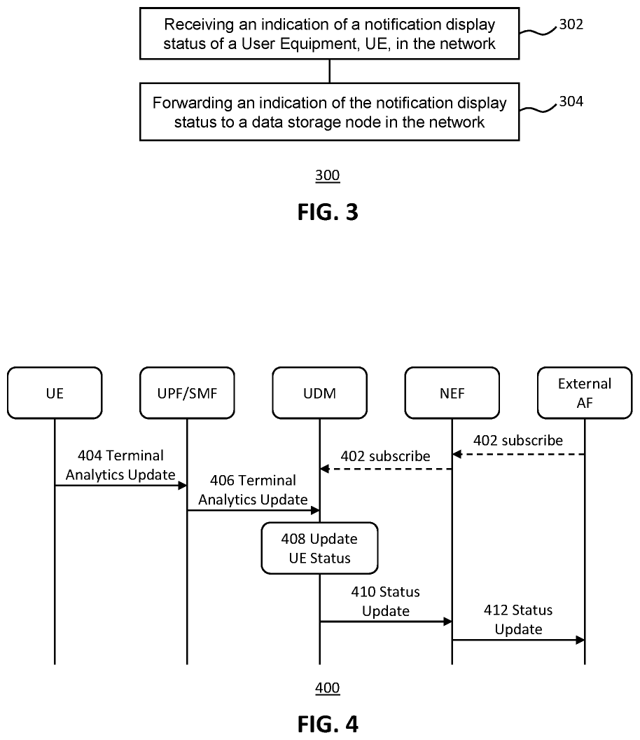

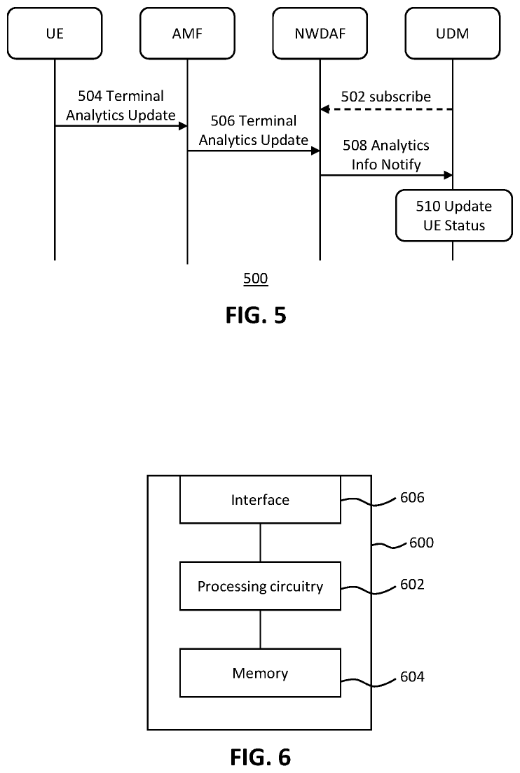

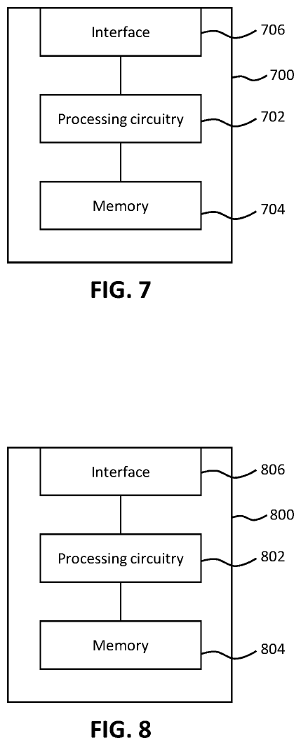

FIG. 3 is a flow chart of an example of a method 300 in a node in a network, such as for example a User Plane Function, UPF, Session Management Function, SMF, Network Data Analytics Function, NWDAF, or Access and Mobility Management Function, AMF. The method comprises, in step 302, receiving an indication of a notification display status of a User Equipment, UE, in the network. This may be received for example from the UE, and for example in response to step 102 or 104 of the method 100 described above. The indication may in some examples be received in the header of one or more PDUs from the UE. Step 304 of the method 300 comprises forwarding an indication of the notification display status to a data storage node in the network (e.g. a UDM).

In some examples, the notification identifies an application. The method 300 may thus comprise forwarding an indication of the notification display status to an Application Server, AS. The AS may be associated with the application, e.g. may be a service provider associated with the application. Thus external nodes such as the AS may be notified of the notification display status, e.g. when it is updated. Thus in some examples the indication of the notification display status to the AS may be forwarded via a Network Exposure Function, NEF.

In some examples the notification display status may comprise a first status or a second status, wherein the first status indicates that the UE will display one or more notifications, and the second status indicates that the UE will not display the one or more notifications (e.g. “Do Not Disturb”).

The following provide non-limiting examples of scenarios where a UE may have a notification display status that indicates notifications should not be displayed. A user may be streaming music on a UE mobile but playing the same on a Bluetooth speaker in a party or home. A user may be streaming videos on mobile (e.g. using 5G wireless communications), for example while travelling or at home. A user may enable a feature (e.g. “Do Not Disturb”) to not display notifications, for example while driving.

In some examples suggested above, an indication of a UE's notification display status may be included in the header of a PDU. In some examples, analytic data may also be included in the header. The frequency with which a UE includes a given piece of analytic data may be based on UE implementation. As an example, a user's location may be provided as analytic data once per hour or once per day. Data Analytic policies are communicated to the UE via NAS as SM Polices from the PCF to the UE via AMF to indicate the network's preferences of what analytic data should be collected by the UE (including its frequency of collection, etc.). The analytic data that the UE collects may based for example on the network preferences and/or UE implementation. In some examples, when the UE has analytic data (e.g. an updated notification display status, or other analytic data) to send and no PDU data to send, the UE may send the only the header and an empty PDU (e.g. empty data part of the PDU) in order to convey the analytic data to network.

In some examples, the UE may indicate to the network (e.g. at network registration) if it supports the optional header to upload analytic data and/or a UE's notification display status. In some examples, if SMF policies dictate that the header should be enabled and the UE indicated its support in the 5GSM Core Network Capability, then the SMF selects a UPF to process headers from the UE and indicates to the UPF, for example in a N4 Session Establishment/Modification Request. The SMF may indicate to the UE, in the PDU Session Establishment Accept, if the optional header should be included in the uplink PDUs. The SMF may indicate to the Radio Access Network (RAN), in N2 SM information, if the optional header will be included in uplink PDUs of the PDU session. The RAN may in some examples take this information into account when performing header compression for the PDU session.

Particular examples will now be described. In some examples of this disclosure, UE analytics shall provide an update (e.g. of a notification display status) to the network on certain actions, such as for example enabling or start of a particular application or functionality within that application. Examples include video streaming and gaming applications. These applications may have “Do Not Disturb” configurations which prevent the rendering of notifications, such as incoming call indications, to enhance the overall user experience. This information can be used by the network for optimizations within the network.

In a first example, a UE may set its notification display status directly with a UDM. Whenever a notification display status of a UE is updated (e.g. in response to start or use of an application), information including for example information identifying the application (ID or name), application characteristics (e.g. if the application is associated with a “Do Not Disturb” status), expected high usage of data by the application, expected low latency requirement of the application, and/or any other information may be shared with the network. This information may be provided by the UE towards network using UE Analytics procedures, e.g. including the information in the header of one or more PDUs (e.g. according to 3GPP TR 23.791, Solution 6.15—Providing UE Analytics to the NF via the User Plane). The UPF or SMF receiving the PDU(s) may extract the Analytics information from the header and provide the information to the UDM. For example, when the app is initiated, the UDM can combine this information with other call forwarding information for the user and enable unconditional call forwarding or rejecting for the user, whereby the network automatically forwards or rejects incoming calls for the user. Also, when the app is closed, the UDM can disable unconditional call forwarding/rejecting. In some examples, the UDM may optionally send to the UE a “Missed Call Alert” message (or indication of other types of communications that were not forwarded to the UE).

In some examples, an application function (AF) or application server (AS) can subscribe to an event in the network for their respective action. For example, an AF or AS can subscribe to receive an update when the notification display status of a UE is updated as a result of opening or use or any other action of an associate application. Once such an event is triggered and is notified to the network (e.g. through notification of an updated notification display status), this information may be shared to an AF or AS via a NEF.

In a second example, a Network Data Analytics Function (NWDAF) may be involved in the process. For example, the information described above that is shared with the UDM may instead be shared with a NWDAF (e.g. via intermediate NFs). The NWDAF may in turn share information for storage at the UDM.

FIG. 4 shows an example of a procedure 400 for sharing terminal analytics in a network. In particular, communications between a UE, UPF/SMF, UDM, NEF and an external AF are shown. In step 402, the external AF subscribes to notification of a UE status change event at the UDM via the NEF. The UE then updates its notification display status, for example in response to any of the events or actions disclosed herein. In step 404, the UE shares this information (and may include other information such as UE info, app ID, app name, etc.) towards the UPF/SMF. In some examples, this information is provided by the UE using UE Analytics data transformation using User plane communication (part of 3GPP TR 23.791, Solution 6.15—Providing UE Analytics to NF via the User Plane).

In step 406, the UPF/SMF forwards the received information to the UDM. In step 408, the UDM updates the stored notification display status for the UE. The UDM may also in some examples combine this information with other forwarding information for the user (e.g. call forwarding information), and set the status of the UE in the network to e.g. “Unconditional Call Forwarding (to another number or Voicemail)” or “reject the incoming call with “Called Party Busy” depending on the updated status.

In step 410, at least some of the information received at the UDM may also be shared towards the NEF as per the event notification subscription by the external AF. In step 412, the NEF forwards the information to the external AF.

In some examples, where no external AF subscribes to notification of a status update event of the UE or such functionality is not available or enabled, the procedure 400 may comprise steps 404 to 408.

FIG. 5 shows another example of a procedure 500 for sharing terminal analytics in a network. In particular, communications between a UE, AMF, NWDAF and UDM are shown. In step 502, the UDM subscribes at the NWDAF for updates to a UE's application start/stop events (or app functionality enabling or use), for example with “Do Not Disturb” status configurations. The UE then updates its notification display status, for example in response to any of the events or actions disclosed herein. In step 504, the UE shares this information (and may include other information such as UE info, app ID, app name, etc.) towards the AMF. In some examples, this information is provided by the UE using UE Analytics data transformation using User plane communication (part of 3GPP TR 23.791, Solution 6.15—Providing UE Analytics to NF via the User Plane).

In step 506, the UPF/SMF forwards the received information to the NWDAF. The NWDAF may then build or update a repository with received information. In step 508, the NWDAF may notify the UDM of the updated notification display status of the UE and may include at least some of the information sent to the NWDAF in step 506. In step 510, the UDM updates the stored notification display status for the UE. The UDM may also in some examples combine this information with other forwarding information for the user (e.g. call forwarding information), and set the status of the UE in the network to e.g. “Unconditional Call Forwarding (to another number or Voicemail)” or “reject the incoming call with “Called Party Busy” depending on the updated status.

FIG. 6 is a schematic of an example of apparatus 600 in a UE. The apparatus 600 comprises processing circuitry 602 (e.g. one or more processors) and a memory 604 in communication with the processing circuitry 602. The memory 604 contains instructions executable by the processing circuitry 602. The apparatus 600 also comprises an interface 606 in communication with the processing circuitry 602. Although the interface 606, processing circuitry 602 and memory 604 are shown connected in series, these may alternatively be interconnected in any other way, for example via a bus.

In one embodiment, the memory 604 contains instructions executable by the processing circuitry 602 such that the apparatus 600 is operable to determine an update of a notification display status of the UE, and provide an indication of the updated notification display status to a node in the network. In some examples, the apparatus 600 is operable to carry out the method 100 described above with reference to FIG. 1.

FIG. 7 is a schematic of an example of apparatus 700 in a node in a network. The apparatus 700 comprises processing circuitry 702 (e.g. one or more processors) and a memory 704 in communication with the processing circuitry 702. The memory 704 contains instructions executable by the processing circuitry 702. The apparatus 700 also comprises an interface 706 in communication with the processing circuitry 702. Although the interface 706, processing circuitry 702 and memory 704 are shown connected in series, these may alternatively be interconnected in any other way, for example via a bus.

In one embodiment, the memory 704 contains instructions executable by the processing circuitry 702 such that the apparatus 700 is operable to receive an indication of a communication for a User Equipment, UE, in the network, determine a notification display status of the UE, if the notification display status is a first status, cause the communication to be forwarded to the UE, and if the notification display status is a second status, prevent the communication from being forwarded to the UE. In some examples, the apparatus 700 is operable to carry out the method 200 described above with reference to FIG. 2.

FIG. 8 is a schematic of an example of apparatus 800 in a node in a network. The apparatus 800 comprises processing circuitry 802 (e.g. one or more processors) and a memory 804 in communication with the processing circuitry 802. The memory 804 contains instructions executable by the processing circuitry 802. The apparatus 800 also comprises an interface 806 in communication with the processing circuitry 802. Although the interface 806, processing circuitry 802 and memory 804 are shown connected in series, these may alternatively be interconnected in any other way, for example via a bus.

In one embodiment, the memory 804 contains instructions executable by the processing circuitry 802 such that the apparatus 800 is operable to receive an indication of a notification display status of a User Equipment, UE, in the network, and forward an indication of the notification display status to a data storage node in the network. In some examples, the apparatus 800 is operable to carry out the method 300 described above with reference to FIG. 3.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method in a User Equipment, UE, in a network, the method comprising:
determining an update of a notification display status of the UE; and
providing an indication of the updated notification display status to a node in the network.

2. The method of claim 1, wherein the node in the network comprises a node in a core network.

3. The method of claim 1, wherein the node in the network comprises a User Plane Function, UPF, Session Management Function, SMF, Unified Data Management, UDM, Network Exposure Function, NEF, Network Data Analytics Function, NWDAF, and/or Access and Mobility Management Function, AMF.

4. The method of claim 1, wherein the notification display status comprises a first status or a second status, wherein the first status indicates that the UE will display one or more notifications and the second status indicates that the UE will not display the one or more notifications.

5. The method of claim 4, wherein the one or more notifications comprise one or more notifications of one or more text messages, alerts, emails, incoming calls, and/or application notifications.

6. The method of claim 4, wherein the updated notification status comprises the second status, and the method comprises receiving a notification from the network of one or more communications for the UE that were not forwarded to the UE based on the second status.

7. The method of claim 4, wherein the second status comprises a Do Not Disturb, DND, status.

8. The method of claim 1, comprising providing the indication of the updated notification display status to the node in the network in a header of one or more Protocol Data Units, PDUs.

9. The method of claim 1, wherein determining the update of the notification display status of the UE comprises receiving an indication of the update of the notification status from an application on the UE.

10. The method of claim 9, wherein providing the indication of the updated notification display status to the node in the network comprises providing an indication identifying the application to the node in the network.

11. A method in a node in a network, the method comprising:
receiving an indication of a communication for a User Equipment, UE, in the network;
determining a notification display status of the UE;
if the notification display status is a first status, causing the communication to be forwarded to the UE; and
if the notification display status is a second status, preventing the communication from being forwarded to the UE.

12. The method of claim 11, wherein determining the notification display status of the UE comprises retrieving the notification display status from a data storage node in the network.

13. The method of claim 12, wherein the data storage node comprises a Unified Data Management, UDM.

14. The method of claim 11, wherein causing the communication to be forwarded to the UE comprises forwarding the communication to the UE, and preventing the communication from being forwarded to the UE comprises refraining from forwarding the communication to the UE.

15. The method of claim 11, wherein the communication comprises one or more text messages, alerts, emails and/or incoming calls for the UE.

16. The method of claim 11, comprising, if the notification display status is a second status, providing a notification of the communication to the UE.

17. The method of claim 11, wherein the communication comprises an incoming call for the UE, and the method (200) comprises, if the notification display status is a second status, forwarding the incoming call to voicemail or an alternative number.

18. The method of claim 17, wherein the notification display status includes an indication of the alternative number.

19. The method of claim 11, wherein the first status indicates that the UE will display one or more notifications and the second status indicates that the UE will not display the one or more notifications.

20. The method of claim 19, wherein the one or more notifications comprise one or more notifications of one or more text messages, alerts, emails, incoming calls, and/or application notifications.

21-43. (canceled)
